(19) United States
(12) Patent Application Publication
(10) Pub. No.: US 2020/0025415 A1
(43) Pub. Date: Jan. 23, 2020

(54) HEATING ADAPTOR

(71) Applicant: Roberts-Gordon LLC, Buffalo, NY (US)

(72) Inventor: Cyrus Efterkharihia, Williamsville, NY (US)

(21) Appl. No.: 16/042,537

(22) Filed: Jul. 23, 2018

(51) Int. Cl. F24H 9/14; F16L 25/14; F23C 3/00; F23C 5/02; F24H 3/08

(52) U.S. Cl. CPC F24H 9/14; F16L 25/14; F24H 3/087; F23C 5/02; F23C 3/002

(57) ABSTRACT

The present invention is directed to a heating adaptor device and method to use that heating adaptor device to replace a 1960-era infrared heater with a modern infrared heater while retaining a 1960-era pipe system. Without the heating adaptor device, (a) the 1960-era pipe system has to be replaced to avoid the known deleterious effects that would occur.

### FIELD OF THE INVENTION

This invention is directed to an infrared heating device and how to update selected infrared heating devices.

### BACKGROUND OF THE INVENTION

Roberts-Gordon, the assignee of this application, has manufactured radiant heating devices for over 50 years. That fact is confirmed by Roberts-Gordon's U.S. Pat. No. 3,394,866 that issued on Jul. 30, 1968. In that patent, Roberts-Gordon disclosed a control device for gas burners used in its infrared heating systems. In the '866 patent, Roberts-Gordon disclosed a 1968 state of art infrared heater that was “designed to obtain the correct proportions of fuel and air at subatomic pressures, even if the pressure air or gas varies.” See, abstract.

Roberts-Gordon made durable infrared heater systems. Some of those 1960-era infrared heaters are expiring and need to be replaced with modern infrared heaters. The modern infrared heaters are more fuel and air efficient than the 1960-era devices. Moreover, the modern infrared heaters meet current building codes and standards by heating associations, for example and not limited to ASHRAE.

The 1960-era infrared heater system 10 and the modern infrared heater system 10′ have many common features. First, each has a housing 15 which has internal components therein. The internal components, are not relevant for this application, but the internal components control (a) the quantity and direction of air, received from pipe 16, used in the housing 15 and (b) the quantity and direction of fuel, received from pipe 22, used in the housing 15. Once the air and fuel are within the housing 15, the housing components direct the desired quantity of fuel and air toward a first mixing duct 43 and, possibly, a second mixing duct 61. The first mixing duct 43 directs the mixed fuel and air to a burner 25 (see, FIG. 1), 25′ (see, FIG. 2) that is positioned in a combustion chamber 68 of pipe 6. The second mixing duct 67 directs the mixed fuel and air, or an electrical circuit to a spark generating device 65 (see, FIG. 1), 65′ (see, FIG. 2) to create a pilot light or equivalent thereof 66. The pilot light 66 is positioned near the burner 25, 25′ to generate the desired heat, from the fuel and air that exits the burner 25, 25′ in the pipe 6.

As expressed in the '886 patent at column 3, lines 26-40, “It has been found desirable to deflect the air or products of combustion entering through [a] pipe [107] in such a manner as to prevent this air [from the pipe 107] from blowing the pilot flame away from the burner 25. For this purpose, . . . a baffle 80 [is used in the 1960-era infrared heater] which is partly circular to extend with a spring action to the side walls of the burner 25 but spaced from the lower wall thereof. This baffle springs into place against the inside walls and consequently prevents any air or products of combustion from the pipe 107 from passing into the combustion chamber [68] . . . at the side of the wall 70 so that all of this air or products of combustion pass below the baffle 80 which thus protects the pilot flame from any flow of air or products of combustion adjacent to the opposite sides of the wall 70.” No such baffle device is required in modern infrared heaters since the spark generating device 65′ creates a more durable pilot light 66.

As expressed in the '886 patent, “Gas fired infrared radiant tube heaters have been developed in many forms. They vary by input, length, size of the radiant tube heat exchanger, also called a radiant pipe or emitter tube, as well as by other factors. Typical [gas fired infrared radiant tube heating systems or components] are [disclosed at U.S. Pat. Nos. 3,394,886, 3,416,512, 5,211,331, EP 0 070 360, GB 2,189,314 A, CA 1,011,314, and GB 2,274,703.] These devices are utilized for heating people within . . . enclosed spaces, for example the space within a building, such as an auditorium, factory building, aircraft hanger, house of worship, vehicle service facility, warehouse, or public hall. Infrared heating has particular application in heating spaces where there are high ceilings. Thus, infrared heating heats from the floor up, greatly reducing heat stratification to the ceiling. Thus there is no need to employ down-draft fans to recover heat lost at the ceiling. In addition, as air temperatures are lower at the ceiling, transmission losses to the outside air are far lower. Infrared heating also has particular application in buildings which have high air change rates, for example aircraft hangers and vehicle service facilities. When the doors to these facilities are opened, most of the warm air is lost to the outside. To reestablish people comfort, if heated with warm air, the interior air volume has to be reheated and driven down from the ceilings. However, if heated with radiant heat, as the floor and surrounding objects are large heat reservoirs, warmth is drawn up and out of the floor, achieving people comfort quickly while larger building spaces may still be at a minimum air temperature. While an infrared heater has particular application for heating people within a fully enclosed space within a building, these heaters have other applications. Thus they may be used to heat people within partially enclosed spaces such as open walkways, grandstands, and tee boxes at golf driving ranges.

There has been an increasing need for heaters with greater thermal output. An infrared radiant tube heater's output capacity is generally limited by the type and size of the tubular heat exchanger connected to it. Thus, there is an effective maximum fueling rate for a radiant pipe of a given diameter and length. A major drawback to the continuing trend of higher thermal output from a single burner assembly is that the heat distribution is generally poor. This is because as fueling rates are increased for radiant pipes of a given diameter and length, hot spots will be created. Unless the building in which such a heater is installed is of sufficient height, there will likely be uncomfortable conditions below the hottest portion of the heat exchanger. The easiest way to solve this problem is to install more heating systems at a lower thermal output thus eliminating the large hot spot from a larger heater and providing more even distribution of the infrared heat. This method causes installation costs to be higher than that of an installation with the higher thermal output burners, as each burner system is provided with its own valve and control circuit module.”

A problem with replacing a 1960-era infrared heater with a modern infrared heater is that the equipment has changed over the years. For example, the pipe 6 used in association with a 1960-era infrared heater 10 has an inner diameter of 6 inches and a top opening 600 of 3.15 inches to accommodate the 1960-era infrared heater's main burner 25 (see, FIG. 1). In contrast, the pipe (not shown) used in association with a modern infrared heater 10′ has an inner diameter of 8 inches and a top opening 600 of 3.15 inches to accommodate the modern control device's main burner 25′. That diameter differential is critical for this invention.

Another common feature for the 1960-era infrared heaters and the modern infrared heaters is how both attach to their respective pipe. The spark generating device 65, 65′ and the burner 25, 25′ extend downward from a securing plate 688 (see, FIG. 5) into the pipe. The securing plate 688 has a pair of apertures 75 that extend from the securing plate's top surface 677 to the securing plate's bottom surface 679. Likewise, the respective pipe, in proximity to the top opening 600, has a corresponding pair of protruding mounting studs 681 that are designed to align with the securing plate's pair of apertures 75 when the spark generating device 65, 65′ and the burner 25, 25′ are properly positioned within the pipe's combustion chamber 68. Once the apertures 75 are aligned with the protruding mounting studs 681, the securing plate 68 is secured onto the pipe 6 by conventional securing means 679, such as winged nuts, threaded screws, threaded bolts, pins, locking pins or equivalents thereof 83 that attach to the protruding mounting studs 681.

The 1960-era main burner 25 has an essentially cuboidal structure having a first length (L₁) of 4 inches, a first depth (D₁) of 2 inches, and first width (W₁) of 4 inches, wherein a back wall 70 slopes toward an exhaust wall 72. In contrast, the modern main burner 25′ has a tapered cuboidal structure, see, FIG. 5, having a second length (L₂) of 5 inches, a second depth (D₂) of 2 inches, and second width (W₂) of 4 inches, wherein a back wall 70′ slopes toward an exhaust wall 72′. That one inch differential is significant.

When the modern infrared heater replaces 1960-era infrared heater in 1960-era pipes, the modern infrared heater's main burner 25′ contacts or nearly contacts the 1960-era pipe's bottom surface, as illustrated at FIG. 2. That bottom contacting pipe result is undesirable for numerous reasons.

First, it is inefficient for air and fuel flow. Second, it heats the pipe in such a way that it can cause the pipe to become defective. Third, it causes heat spots in the pipes which can be deleterious.

It is therefore important to solve a problem that permits a person to replace a 1960-era infrared heater with a modern infrared heater while using and maintaining the 1960-era pipes that remain functional and practical.

### SUMMARY OF THE FIGURES

FIG. 1 is a cross-sectional view of a 1960-era infrared heater in a 1960-era pipe system. This is prior art.

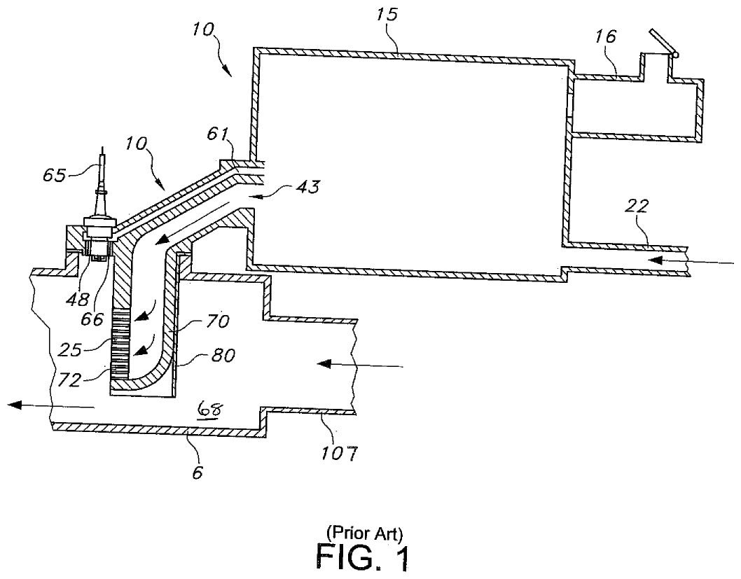

FIG. 2 is a cross section view of a modern infrared heater in a 1960-era pipe system. This is prior art.

FIG. 3 is a heating adaptor.

FIG. 4 is a cross section view of a modern infrared heater in a 1960-era pipe system with a heating adaptor.

FIG. 5 is an exploded view of FIG. 4 taken along the lines 5-5.

### SUMMARY OF THE INVENTION

The present invention is directed to a heating adaptor device and method to use that heating adaptor device to replace a 1960-era infrared heater with a modern infrared heater while retaining a 1960-era pipe system. Without the heating adaptor device, (a) the 1960-era pipe system has to be replaced to avoid the known deleterious effects that would occur.

### DETAILED DESCRIPTION OF THE INVENTION

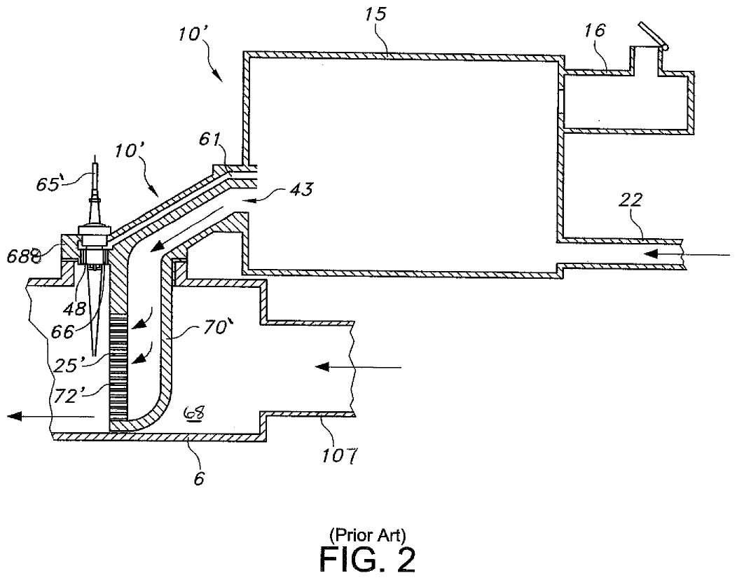

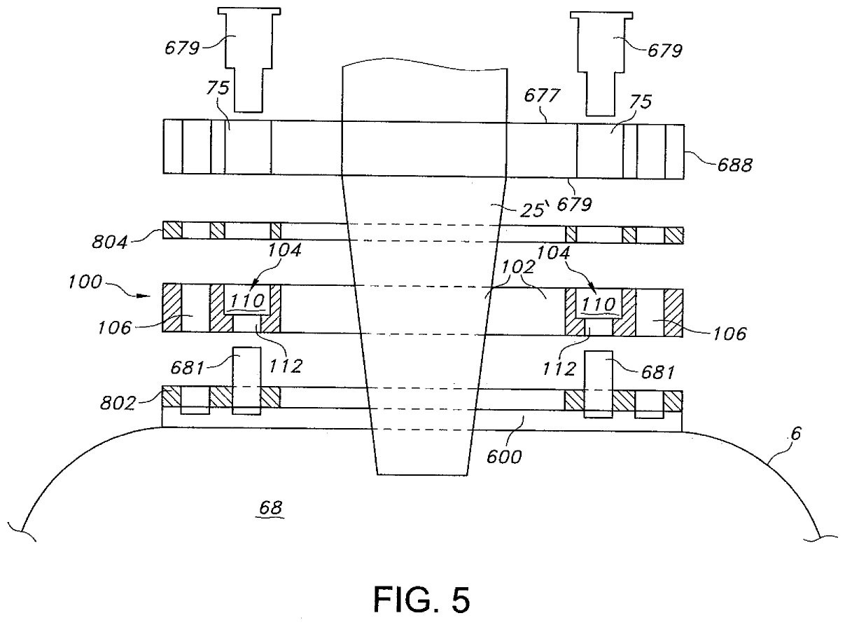

Replacing a 1960-era infrared heater 10 for a modern infrared heater 10′ while using the 1960-era pipes 6 is difficult and potentially deleterious without adding a heating adaptor 100, see FIGS. 2, 4, and 5, for the above-identified reasons.

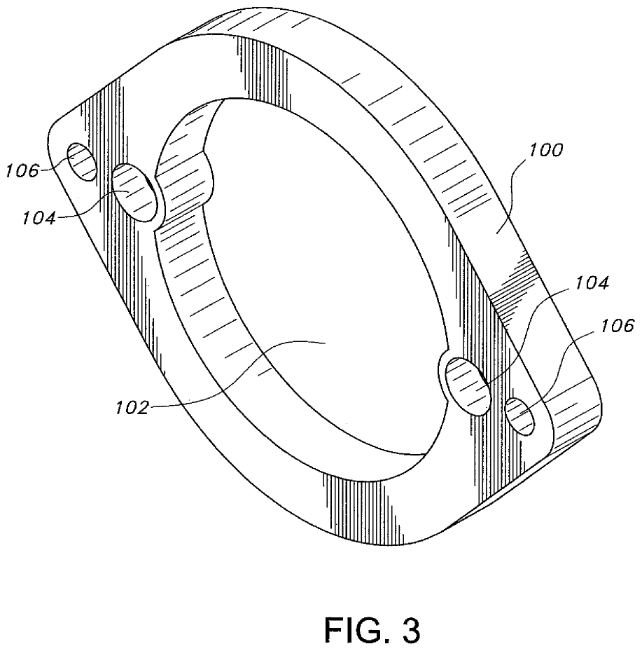

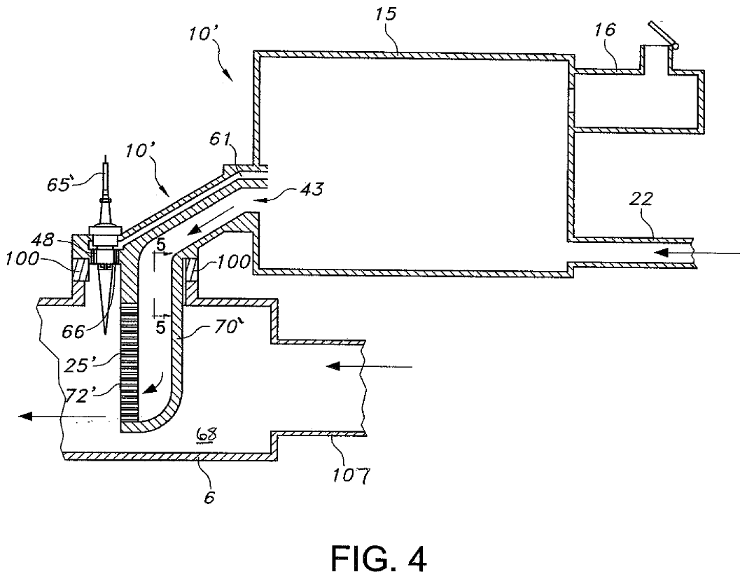

The control adapter 100 is positioned between the securing plate 68 and the pipe 6. The heating adaptor 100, as illustrated at FIG. 3, has a burner/spark-generating aperture 102, a corresponding pair of security apertures 104, and corresponding pair of aligning apertures 106. The pair of security apertures 104 align with the pair of protrusions 681 and the pair of securing plate apertures 75 when the spark generating device 65′ and the burner 25′ are properly positioned in the pipe 6 and the burner/spark-generating aperture 102 as illustrated at FIG. 4.

The heating adaptor 100 raises the burner 25′ of the modern infrared heater 10′ from contacting or getting too close to the bottom surface of the 1960-era pipes 6. Raising the burner 25′ is accomplished by the heating adaptor's height, which is about 0.5 to 2 inches in height.

Each security aperture 104, as illustrated at FIG. 4, has a top section 110 and a bottom section 112. The top section 110 has a greater diameter (DT) than the bottom section's diameter (DB). That diameter difference assists in securing heating adaptor 100, the securing plate 68 and the pipe 6 together with the above-identified securing mechanisms that normally join the securing plate 63 to the pipe 6, except the securing mechanism 679 may now be longer to accommodate the control adapter's height.

The method of utilizing this apparatus includes and is not limited to using applicant's CORAYVAC radiant heaters.

First, a person having ordinary skill in the art must recognize that a 1960-era infrared heater 10 must be replaced with a modern infrared heater 10′ and a desire to continue using the 1960-era pipe system. After receiving the new modern infrared heater 10′, the person then removes the 1960-era infrared heater 10 from the 1960-era pipe system (which includes the pipe 6).

Locate and obtain a modern infrared heater 10′ carton and make sure all the information marked on the box matches the purchaser's order. The modern infrared heater 10′ box contains a burner, accessories, filter, flexible gas line with shut off valve for US customers only (the gas lines are sold separately for some foreign customers), end vent plate, and burner door with the serial plate.

To start the assembly process, locate the modern infrared heater 10′ and set it aside. Next, locate the accessory package that contains the filter door, end vent plate, necessary gasket material, screws and nuts for assembling the filter and securing the modern infrared heater 10′ to the combustion chamber 68. First, assemble a filter door and attach a filter to the filter door. Locate the larger filter gasket. Peel off the backing and fix it on to the bottom of the filter. Next, locate the smaller gasket and the filter support disc. Peel off the backing and affix the gasket to the filter support disc. Insert the filter support tee end of the support through the filter door opening and lock it into place by pulling through. Next, slide the filter and gasket on the filter support. Place the filter support disc onto the filter support and secure with a wing nut. Hand tighten the filter while making sure it is positioned on the center of the filter door. If the filters and gaskets are not properly installed, unfiltered combustion air can enter the burner. Attach the filter door and the burner door with four wing screws provided. Make sure not to cross thread the screws. Hand tighten the screws. Depending upon the application, the filter door and burner door can be placed on either side of the burner.

At this point, the burner combustion chamber and the reflector with the hole must be recognized and installed before proceeding to the next step.

To attach the modern infrared heater 10′ to the combustion chamber 68 of the 1960-era pipe system, place a first combustion chamber gasket 802 on top of the combustion chamber. Place the heating adaptor 100 on top of the first combustion chamber gasket 802. Then place a second combustion chamber gasket 804 on top of the heating adaptor 100. Align the two sets of slots 75 of the securing plate 688 and the security aperture 104 of the adaptor 100, on the cast iron burner head with the two protruding mounting studs 681 on the combustion chamber 68 of the pipe 6 and insert the burner head assembly 25′ onto the combustion chamber. Make sure that the burner head is facing in the direction towards the vacuum pump (not shown). Place a locking washers 679 on the combustion chamber threads using 5/16th nuts to secure the burner to the combustion chamber. DO NOT over tighten.

Next, locate the end vent plate. Every burner is shipped with one end vent plate matching the burner rate. Only install the end vent on the first burner position. Disregard the end vent plate if the burner is not located at the end of the radiant branch. Verify if you have the end vent plate for your burner assembly by locating the number stamped on the end vent. The stamp number correlates with the BTU rating of the burner. For example if the burner is 40,000 btu, the number stamped on the end vent will be the number four. Using the end vent plate clips, place the u-clips through the end vent cut outs. Place the end vent plate against the combustion chamber and push the u-clips on to the combustion chamber. Make sure that the end vent plate rating is located on bottom and placing the installer.

Modern infrared heater 10′ sold in the US are supplied with a flexible gas line and shut-off valve. Gas lines are sold separately for many foreign customers. The flexible gas line length is determined by the manufacturer to ensure the length is adequate for expansion and contraction. Make sure that you use the flexible gas line provided by Roberts-Gordon to ensure proper installation.

Next, attach the flexible line to the gas nipple located at the burner. The gas shut off valve, must be placed on the opposite end so the burner can be removed in the future. Use a wrench to hold the gas nipple in place and tighten the gas line. The flexible gas line must form a ‘C’ shape with a 12-inch distance between ends so the flexible gas line can move freely. The gas line installation must also be parallel to the tubing run.

While the invention has been described using some specific examples, many modifications and variations are possible. It is therefore understood that the invention is not intended to be limited in any way, other than by the scope of the appended claims.

1. A heating adaptor device to properly replace
A) a 1960-era infrared heater having a burner and a spark-generating device, wherein the burner and the spark-generating device protrude downwardly into a combustion chamber of a 1960-era pipe system, wherein the burner does not contact the pipe system's surface when the 1960-era infrared heater is securely attached to the 1960-era pipe system; with
B) a modern infrared heater having a modern burner and a modern spark-generating device, wherein the modern burner and the modern spark-generating device protrude downwardly into a combustion chamber of the 1960-era pipe system, wherein the modern burner contacts the pipe system's surface when the modern infrared heater is securely attached to the 1960-era pipe system without the adaptor device;
the heating adaptor device comprising:
metallic structure having a predetermined height, a pair of security apertures, and a burner aperture to (a) receive the modern burner and the modern spark-generating device and (b) permit the modern burner not contact the pipe system's surface;
a first gasket positioned between the adaptor device and the modern infrared heater and a second gasket positioned between the adaptor device and the combustion chamber of a 1960-era pipe system; and
each security aperture extends from the metallic structures top surface to bottom surface, and has (a) a bottom opening extending from the bottom surface toward the top surface and receives a mounting stud that upwardly protrudes from the combustion chamber of a 1960-era pipe system and (b) a top opening extending from top surface toward the bottom surface, has a greater diameter than the bottom opening, and receives a securing mechanism that engages with the mounting stud to secure the modern infrared heater, the heating adaptor and the 1960-era pipe system together.

2. A method of using a heating adaptor device to properly replace
A) a 1960-era infrared heater having a burner and a spark-generating device, wherein the burner and the spark-generating device protrude downwardly into a combustion chamber of a 1960-era pipe system, wherein the burner does not contact the pipe system's surface when the 1960-era infrared heater is securely attached to the 1960-era pipe system; with
B) a modern infrared heater having a modern burner and a modern spark-generating device, wherein the modern burner and the modern spark-generating device protrude downwardly into a combustion chamber of the 1960-era pipe system, wherein the modern burner contacts the pipe system's surface when the modern infrared heater is securely attached to the 1960-era pipe system without the adaptor device;
the heating adaptor device comprising:
metallic structure having a predetermined height, a pair of security apertures, and a burner aperture to (a) receive the modern burner and the modern spark-generating device and (b) permit the modern burner not contact the pipe system's surface;
a first gasket positioned between the adaptor device and the modern infrared heater and a second gasket positioned between the adaptor device and the combustion chamber of a 1960-era pipe system; and
each security aperture extends from the metallic structures top surface to bottom surface, and has (a) a bottom opening extending from the bottom surface toward the top surface and receives a mounting stud that upwardly protrudes from the combustion chamber of a 1960-era pipe system and (b) a top opening extending from top surface toward the bottom surface, has a greater diameter than the bottom opening, and receives a securing mechanism that engages with the mounting stud to secure the modern infrared heater, the heating adaptor and the 1960-era pipe system together.
